(19) United States
(12) Patent Application Publication
(10) Pub. No.: US 2024/0164244 A1
(43) Pub. Date: May 23, 2024

(54) AN AGRICULTURAL IMPLEMENT, A COMPUTER PROGRAM, A COMPUTER-READABLE MEDIUM AND A METHOD FOR CONTROLLING AN AIRFLOW IN A FEED SYSTEM FOR AN AGRICULTURAL PRODUCT OF THE AGRICULTURAL IMPLEMENT

(71) Applicant: VÄDERSTAD HOLDING AB, Väderstad (SE)

(72) Inventor: Astrid KARLSSON, Mjölby (SE)

(21) Appl. No.: 18/548,643

(22) PCT Filed: Mar. 11, 2022
(86) PCT No.: PCT/SE2022/050244

§ 371 Date: Sep. 1, 2023

(30) Foreign Application Priority Data
Mar. 11, 2021 (SE) 2150277-8

(51) Int. Cl. A01C 7/08; A01C 15/00; A01C 15/04; B65G 53/66; G01F 1/40

(52) U.S. Cl. CPC A01C 7/084; A01C 7/082; A01C 15/003; A01C 15/04; B65G 53/66; G01F 1/40

(57) ABSTRACT

The present disclosure relates to an agricultural implement (1, 4) comprising a feed system for an agricultural product (5). The feed system comprises a flow path (12); an airflow generating unit (14) arranged in fluid communication with the flow path (12); a at least one metering device arranged to provide the agricultural product (5) to the airflow in the flow path (12); at least one distribution unit (20) connected to the flow path (12) downstream of the at least one metering device, wherein the at least one distribution unit (20) comprises at least one outlet (22); at least one sensor (303) arranged to measure a quantity relating to the flow path (12); and a control unit (200) arranged to control (160) the airflow generating unit (14) to obtain a desired airflow in the flow path (12) based on measurements by the at least one sensor (303). The flow path (12) comprises a measurement part comprising a first part having a first cross section area and a second part having a second cross section area. The at least one sensor (303) is arranged to measure a quantity relating to the flow path (12) at the first and second parts. The present disclosure further relates to a method for controlling (150) an airflow in a feed system

### TECHNICAL FIELD

The present invention relates to an agricultural implement comprising a feed system for an agricultural product.

The present invention further relates to a method for controlling an airflow in a feed system for an agricultural product of the agricultural implement.

### BACKGROUND

Agricultural implements for crop production, such as seeding or fertilizing implements, are generally towed by a tractor or work vehicle. The agricultural implements distribute seeds, fertilizers or pesticides by means of a feed system to the ground, where the crops grow. The feed system typically include one or more delivery lines that carry particulate from a product storage tank to product outlets at the ground. The transport of the agricultural product through the feed system may often be controlled by airflow. The performance and precision of the feed system is of major importance in improving efficiency of agricultural yield.

Configuration and control of the feed system for enabling control of the precision of seed spacing, seed depth and no overlap planting is thus essential. In addition, a reliable and efficient product flow within the feed system is a key feature for successful crop production.

US 2020/0077575 discloses a system for distributing particulate material to an agricultural field wherein a controller in communication with an air source is arranged to control the air source to maintain an airflow corresponding to a predetermined airflow setting.

### SUMMARY

An object of the present disclosure is to achieve an advantageous agricultural implement and method for efficient distribution of an agricultural product.

The herein mentioned object is achieved by an agricultural implement, a computer program, a computer-readable medium and a method for controlling an airflow in a feed system for at least one agricultural product of an agricultural implement, according to the appended independent claims.

Hence, according to an aspect of the present disclosure, an agricultural implement is provided comprising a feed system for at least one agricultural product. The feed system comprises a flow path; an airflow generating unit arranged in fluid communication with the flow path; at least one metering device arranged to provide the agricultural product to the airflow in the flow path; at least one distribution unit connected to the flow path downstream of the at least one metering device, wherein the at least one distribution unit comprises at least one outlet; at least one sensor arranged to measure a quantity relating to the flow path; and a control unit arranged to control the airflow generating unit to obtain a desired airflow in the flow path based on measurements by the at least one sensor. The flow path comprises a measurement part comprising a first part having a first cross section area and a second part having a second cross section area, wherein the size of the first cross section area is different from the size of the second cross section area. The at least one sensor is arranged to measure the quantity relating to the flow path at the first part and the second part. Further, the control unit is arranged to control the airflow generating unit to obtain the desired airflow in the flow path based on the measured quantity relating to the flow path at the first part and at the second part and based on a relation between the size of the first cross section area and the size of the second cross section area.

According to an aspect, a method for controlling an airflow in a feed system of an agricultural implement for an agricultural product is provided, wherein the feed system comprises: a flow path; an airflow generating unit arranged in fluid communication with the flow path; at least one metering device arranged to provide the agricultural product to the airflow in the flow path; at least one distribution unit connected to the flow path downstream of the at least one metering device, wherein the at least one distribution unit comprises at least one outlet for conveying the agricultural product to the ground, at least one sensor arranged to measure the quantity relating to the flow path, and a control unit arranged to control the airflow generating unit to obtain a desired airflow in the flow path based on measurements by the at least one sensor. The method comprises measuring at a measurement part of the flow path, using said at least one sensor, the quantity related to a current airflow at a first part having of the measurement part, said first part having a first cross section area and at a second part of the measurement part, said second part having a second cross section area, wherein the size of the first cross section area is different from the size of the second cross section area, and controlling the airflow generating unit to obtain a desired airflow in the flow path based on the measurements of the quantity related to the airflow at the first part and at the second part and based on a relation between the size of the first cross section area and the size of the second cross section area.

According to an aspect, a computer program comprising instructions which, when the program is executed by a computer, cause the computer to carry out the method as disclosed herein, is provided.

According to an aspect, a computer-readable medium comprising instructions that, when executed by a computer, cause the computer to carry out the method as disclosed herein, is provided.

The performance and precision of distributing agricultural product evenly over the ground in the travelling direction is increased, and thereby the crop yield.

By means of the present disclosure, efficient airflow control in the feed system is achieved. Consequently, a more uniform product velocity and thereby a reliable distribution of agricultural product is achieved. Thereby, an increased crop yield can be achieved. An increased crop yield leads to higher profits. A uniform and controlled distribution of agricultural product has also other advantages, such as environmental benefits since the risk of over-fertilization or unwanted pesticide emissions are reduced. In addition, due to increased control of product flow, less agricultural product, such as seeds, goes to waste.

Further, the driver does not need to make any adjustments to the speed of the airflow generating unit. The speed of the airflow generating unit is automatically and continuously adapted to maintain the desired airflow in the flow path.

Further objects, advantages and novel features of the present invention will become apparent to one skilled in the art from the following details.

### BRIEF DESCRIPTIONS OF THE DRAWINGS

For fuller understanding of the present invention and further objects and advantages of it, the detailed description set out below should be read together with the accompanying drawings, in which the same reference notations denote similar items in the various drawings, and in which:

FIG. 1 is a flow chart schematically illustrating examples of a method for controlling an airflow in a feed system for an agricultural product of an agricultural implement.

FIG. 2 illustrates schematically a difference between a feed system transporting a product with a constant velocity airflow and with a varying velocity.

FIGS. 3a and 3b illustrate schematically an example of an adapter in a flow path of feed system for an agricultural product of an agricultural implement.

FIG. 4 schematically illustrates an agricultural implement according to an example of the present disclosure.

FIGS. 5a-5b schematically illustrate a feed system of an agricultural implement according to examples of the present disclosure.

FIG. 6 schematically illustrate a feed system of an agricultural implement according to examples of the present disclosure.

### DETAILED DESCRIPTION

The present disclosure will be described in further detail below. It is to be understood that all the various examples of the agricultural implement also applies for the method for controlling an airflow in a feed system for at least one agricultural product in such an agricultural implement, and vice versa. The same applies for the computer program and the computer-readable medium.

According to an aspect of the present disclosure, an agricultural implement comprising a feed system for at least one agricultural product is provided. The agricultural implement may comprise a planter, a seed drill, a fertilizing applicator, a pesticide applicator and/or any other similar devices. The at least one agricultural product may comprise seeds, fertilizer, pesticides and/or other similar products. The at least one agricultural product may comprise granular, particulate and/or powdery material.

The feed system comprises a flow path and an airflow generating unit arranged in fluid communication with the flow path. The airflow generating unit may comprise a fan, pump or blower. The airflow generating unit may comprise a hydraulically driven fan. The airflow generating unit is controlled by a control signal to control the airflow. Characteristically, the airflow generation unit is controlled to provide a desired airflow in the flow path. This will be discussed more in detail below.

The flow path may have a circular cross section. The flow path may have an oval cross section. The flow path may have any other shape of the cross section. The shape of the flow path in cross section is not relevant to the solution as defined herein. However, a flow path with a substantially circular cross section is preferred in view of airflow characteristics.

The flow path comprises a measurement part comprising a first part having a first cross section area and a second part having a second cross section area. The size of the first cross section area is different from the size of the second cross section area. The measurement part may be formed in an adapter positioned in the flow path. The adapter may be a choke adapter. However, it is not relevant whether the first cross section area is smaller or larger than the second cross section area. Thus, the adapter can instead of forming a choke adapter expand the cross section area in the flow direction. The area change between the first and second area is characteristically smaller than 50%, preferably smaller than 40% and in an example smaller than 30%. Thus, the second area has characteristically less than twice the size than the first cross section area or the second area has characteristically more than half the size of the first cross section area.

At least one sensor is arranged to measure a quantity relating to the flow path at the first and second parts of the measurement part. The at least one sensor may comprise at least one pressure sensor, such as a static pressure sensor. The at least one sensor may comprise at least one airflow sensor such as a vane sensor and/or hot wire sensor. The at least one sensor may be integrally formed with the adapter.

The at least one sensor may comprise a first sensor arranged to measure a quantity at the first part and a second sensor arranged to measure the quantity at the second part. The first sensor may be arranged at the first part of the adapter and the second sensor may be arranged at the second part of the adapter.

In an option, the at least one sensor is integrally formed with the adapter.

The at least one sensor may be arranged at the first and second part, respectively. Alternatively, the first part comprises a first port and the second part comprises a second port, wherein the first and second ports are connected to the at least one sensor. In an option wherein one sensor is used, the first and second ports are connected to the sensor, which sensor measures a differential between the quantity relating to the flow path at the first part and at the second part.

The first and the second sensors are arranged to measure a quantity related to the airflow in the flow path at the respective part of the adapter. For example, the first and second sensors comprise pressure sensors, such as static pressure sensors, or airflow sensors arranged to measure an airflow rate.

The feed system comprises further at least one metering device arranged to supply the agricultural product to the airflow of the flow path. In an option, the measuring part, for example designed as an adapter, is arranged upstream the at least one metering device.

The feed system comprises further at least one distribution unit connected to the flow path downstream of the at least one metering device, wherein the at least one distribution unit comprises at least one outlet for conveying the agricultural product to the ground. In an option, the at least one distribution unit comprises a plurality of outlets. In practice, the at least one outlet may be connected to a separated duct for conveying the agricultural product to the ground.

The flow path may be arranged between the airflow generating unit and the distribution unit. The at least one metering device may be arranged between the airflow generating unit and the distribution unit. The at least one metering device may be arranged downstream of the airflow generating unit and/or upstream of the distribution unit. The adapter may be arranged in the flow path between the airflow generating unit and the at least one metering device. Thus, the adapter is then arranged upstream the at least one metering device.

The at least one metering device may be configured to supply the agricultural product to the airflow generated by the airflow generating unit. The at least one metering device may be controlled to regulate the amount of agricultural product supplied into the airflow in the flow path. The at least one metering device may be arranged to feed agricultural product from a product chamber into the flow path for feeding the agricultural product to the ducts. The product chamber may be essentially funnel shaped with inner walls sloping towards the at least one metering device, so that agricultural product stored in the product chamber falls down towards the at least one metering device by the influence of gravity. The product chamber may be a seed hopper or a fertilizer hopper. The product chamber may be a combined seed and fertilizer hopper, comprising a separate chamber for seeds and a separate chamber for fertilizer. The at least one metering device may comprise a rotating dosing element, such as a rotating cell wheel or a feed screw. The speed and direction of the rotating dosing element affect the feed rate of agricultural product into the flow path. The speed and direction of the rotating dosing element may be regulated by means of a drive unit. The speed and direction of the rotating dosing element may be based on a desired distribution rate and the speed at which the agricultural implement is moving. The desired distribution rate may be a desired amount of agricultural product per unit of surface area. The drive unit arranged to drive the rotating dosing element may be controlled by the control device.

The distribution unit may also be called distribution manifold, distribution head or distributor. The distribution unit may be arranged downstream of the airflow generating unit and the at least one metering device. The at least one distribution unit may as stated above comprise at least two outlets, often more than two outlets. It is not unusual that the at least one distribution unit comprises up to 40 outlets. Each outlet of the distribution unit may be connected to a first end of a separate duct leading the agricultural product to coulters and/or the ground. The second end of each duct may be arranged in association with a coulter and/or some sort of outlet nozzle and is thus arranged close to the soil in order to discharge the agricultural product. The distribution unit may transfer the product flow from the flow path to the at least two ducts. Thus, there may be multiple separate ducts. Thus, the flow path conveys air and agricultural product to the distribution unit, while the ducts may convey agricultural product from the distributing unit towards the ground. According to an example, one or more of the at least two separate ducts may branch out and split into multiple sub-ducts.

According to an example, the feed system may comprise multiple flow paths. The multiple flow paths may each have a separate airflow generating device, or share the same airflow generating device. The multiple flow paths may each have a separate metering device, or share the same metering device.

According to an example, the at least one metering device and the distribution unit may be comprised in a single entity. According to an example, the at least one metering device, the distribution unit and the product chamber may be comprised in a single entity.

The feed system further comprises a control unit arranged to control the airflow generating unit to obtain the desired airflow in the flow path based on sensor measurements by the at least one sensor. In detail, the control unit is arranged to control the airflow generating unit to obtain the desired airflow in the flow path based on the measured quantity relating to the flow path at the first part and at the second part and based on a relation between the size of the first cross section area and the seize of the second cross section area.

The desired airflow may be a preset value. The desired airflow may be user set value. The desired airflow may be user set or automatically set based on the agricultural product or mix of agricultural products.

For example, prior to operation, the user may, via a user interface communicating with the control unit, input data corresponding to the type of agricultural product (e.g. type of crop, fertilizer or pesticide) to be distributed by the agricultural implement.

In an option, the control unit is arranged to provide a signal for control of the airflow generation unit also to a Load Sensing, LS, system/valve, to thereby request a desired hydraulic pressure to the implement based on the control signal.

In an example, the control unit may be arranged to provide an alarm signal to a user interface when the desired airflow cannot be reached.

The alarm may be a visual alarm, an audible alarm, a tactile alarm and/or any other suitable type of alarm. The alarm may thus make the driver aware of that something is wrong with the product flow in the flow path. Activating an alarm is advantageous since necessary measures can be taken immediately and the risk of uneven distribution of agricultural product is reduced.

In addition, the time for maintenance may be reduced, if the problem is discovered and attended to at an early stage.

According to an example, the at least one metering device may be controlled to stop providing any agricultural product to the airflow in the flow path when the current airflow is not the desired airflow.

By terminating the supply of agricultural product to the airflow in the flow path when the airflow is not as desired, potential negative effects are reduced. The termination of the supply of agricultural product may be initiated manually by the driver or automatically by the control unit.

According to an aspect of the disclosure, a computer program comprising instructions that, when the program is executed by a computer, cause the computer to carry out the method according to the method as disclosed herein is provided. By means of the computer program, an increased control and accuracy of the detection method may be obtained. The computer program causes the agricultural implement to perform the above methods steps when executed, with increased predictability and reproducibility.

According to an aspect of the disclosure, a computer-readable medium comprising instructions which, when executed by a computer, cause the computer to carry out the method according to the method as disclosed herein is provided. The computer-readable medium may be any tangible and/or non-transitory medium that may contain or store a program for execution by a processor.

It will be appreciated that all the examples described for the method aspect of the disclosure performed by the control device are also applicable to the agricultural implement aspect of the disclosure. That is, the agricultural implement comprising the control device may be configured to perform any one of the steps of the method according to the various examples described above.

It is to be understood that the control unit may be implemented as a separate entity or distributed in two or more physical entities. The control unit may comprise one or more control units and/or computers. The control unit comprises characteristically a processor and a memory, the memory comprising instructions, which when executed by the processor causes the control device to perform the herein disclosed method steps. Effects and features of the aspects relating to the control device correspond to those described above in connection with the method. In addition, examples mentioned in relation to the method are compatible with the agricultural implement/control device aspect, and vice versa.

The present disclosure will now be further illustrated with reference to the appended figures, wherein for the sake of clarity and understanding of the disclosure some details of no importance for the understanding of the invention are deleted from the figures. Moreover, the figures shall not be considered drawn to scale as some features may be exaggerated in order to more clearly illustrate the disclosure. In the figures, some preferred examples of the present disclosure are shown. The invention may, however, be embodied in other forms and should not be construed as limited to the herein disclosed examples. The disclosed examples are provided to fully convey the scope of the disclosure to the skilled person.

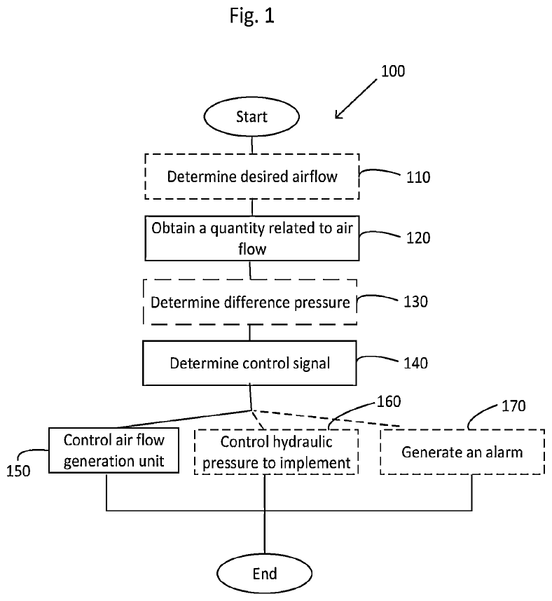

FIG. 1 illustrates schematically a method 100 for controlling an airflow in a feed system for at least one agricultural product of an agricultural implement, the feed system comprising: a flow path; an airflow generating unit arranged in fluid communication with the flow path; at least one metering device arranged to provide the agricultural product to the airflow in the flow path; at least one distribution unit connected to the flow path downstream of the metering device, wherein the at least one distribution unit comprises at least one outlet for conveying the agricultural product to the ground; at least one sensor arranged to measure a quantity relating to the flow path; and a control unit arranged to control the airflow generating unit to obtain a desired airflow in the flow path based on measurements by the at least one sensor.

The method comprises obtaining 120 a measurement at a measurement part of the flow path, using said at least one sensor, the quantity related to a current airflow at a first part having of the measurement part, said first part having a first cross section area and at a second part having a second cross section area, wherein the size of the first cross section area is different from the size of the second cross section area. The quantity measured by the at least one sensor is for example a pressure, such as a static pressure, or an airflow, or a differential pressure, such as a differential static pressure, or a differential airflow.

A differential pressure is provided from the obtained measurement. For example, the method comprises a step of determining 130 the differential pressure based on the measurements of the quantity related to the airflow. The determination of a differential pressure is in an example based on a relation between the measurement of quantity by first and second sensors, wherein the first sensor measures the quantity at the first part and the second sensor measures the quantity at the second part. In an example, the first and second sensors comprise airflow sensors arranged to measure an airflow rate. Thus, in accordance with this example, the differential pressure is determined without having to measure actual pressures at different locations along the flow path.

The method further comprises a step of determining 140 a control signal for controlling the airflow generating unit to obtain a desired airflow in the flow path. The control signal for controlling the airflow generating unit is characteristically determined based on the differential pressure and a relation between the size of the first cross section area and the size of the second cross section area.

The method further comprises a step of providing to the airflow generating unit the control signal for controlling 150 the airflow generating unit. Characteristically, the control signal is provided to a valve of the airflow generating unit.

In an example, the control signal is also provided to a Load Sensing, LS, system or valve of a tractor to which the implement is connected. The LS system/valve is arranged to control 160 a hydraulic pressure supplied to the implement. The LS system/valve can then be arranged to provide a suitable hydraulic pressure to the implement based on the control signal. For example, the hydraulic pressure supplied to the implement may be set to be a predetermined value higher than the hydraulic pressure presently required by the airflow generating unit to generate an airflow in accordance with the control signal. For example, the hydraulic pressure supplied to the implement may be set to be 20 bar higher than the hydraulic pressure presently required by the airflow generating unit to generate an airflow in accordance with the control signal. This functionality of adapting the hydraulic pressure supplied to the implement to the need as defined by the control signal would be energy saving.

The method may further comprise a step of monitoring the control signal for controlling the airflow generating unit and when it has been determined that the control signal exceeds a predetermined maximum value, generating 170 an alarm indicating that the desired airflow will not be reached. Thus, an instant feedback is provided if the agricultural product is likely not supplied as intended and a user may then have a chance to remove the cause of this deviation. If a high precision in supply of the agricultural product is of essence, the metering device may be controlled to stop supplying the agricultural product when it has been determined that the control signal exceeds the predetermined maximum value.

The method may further comprise an initial step of determining 110 the desired airflow. For example, prior to operation, the user may, via a user interface communicating with the control unit, input data corresponding to the type of agricultural product (e.g. type of crop, fertilizer or pesticide) to be distributed by the agricultural implement. The airflow may then be determined based on the selected agricultural product or mix of agricultural products. Alternatively, the user interface provides a plurality of pre-set airflow selections and the user can select one of those via the user interface. For example, the user selection is made via a touch display or other types of controls for selecting an airflow.

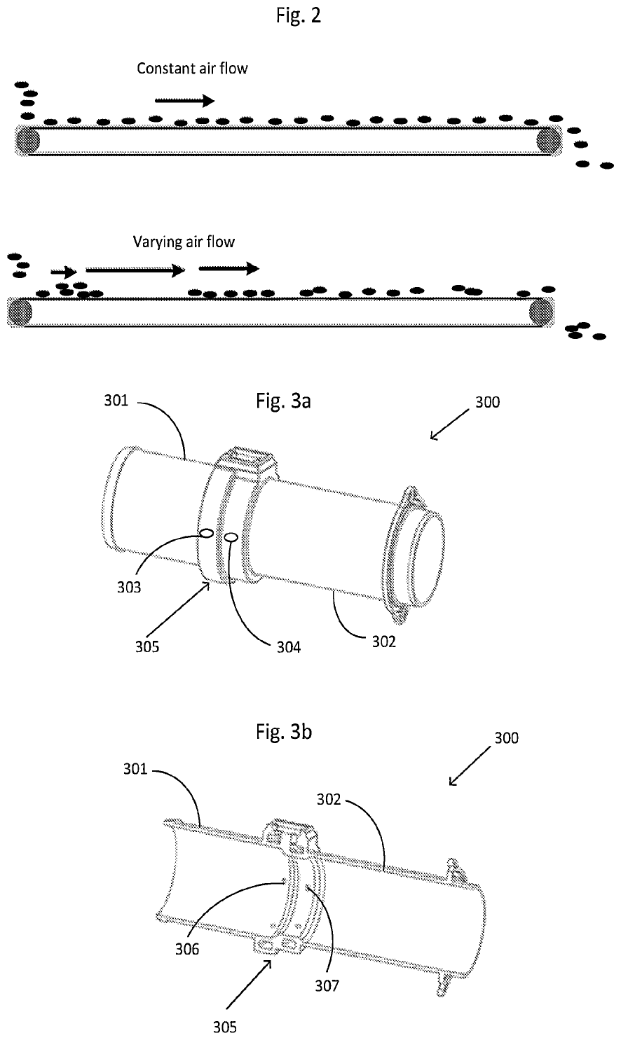

FIG. 2 illustrates the importance of a providing a constant product transport velocity in a feed system for an agricultural product. In the illustration of FIG. 2, the flow path is illustrated as a conveyor belt for better illustrating the effect of a varying airflow. Thus, in this figure, the velocity of the transport band transporting the product is equivalent to the airflow of the system as disclosed herein.

In the upper part of the figure, feeding with a constant product transport velocity is illustrated, which allows for an even distribution of the agricultural product along the direction of movement of the feed system. In the lower part, feeding with a varying product transport velocity is illustrated; the agricultural product is here unevenly distributed along the direction of movement of the feed system.

In FIGS. 3a and 3b an example is illustrated of an adapter 300 for use as a measurement part in the method for controlling an airflow in a feed system as discussed herein, for example in relation to FIG. 1. Thus, the illustrated adapter can be mounted and demounted from the flow path. The adapter can be turned either way in the flow path. However, in the following, the adapter will be exemplified as a choke adapter.

A cross section area of the adapter is in the illustrated example substantially circular.

The adapter 300 comprises a first part 301 having a first cross section area and a second part 302 having a second cross section area. The first cross section area is different from the second cross section area. A choke part 305 connects the first part 301 to the second part 302 Further, in the illustrated example, a first port 306 is arranged in the first part 301 having the first cross section area and a second port 307 is arranged in the second part 302 having the second cross section area. The first and second ports 306, 307 are connected to at least one sensor 303, 304. The at least one sensor may comprise one sensor arranged to measure a differential pressure or air velocity or the like. In accordance with this example, both ports 306, 307 are connected to the same sensor. Alternatively, the at least one sensor comprises a first sensor 303 arranged to measure the quantity in the first part 301 and a second sensor 304 arranged to measure the quantity in the second part. In this example, the first port 306 is connected to the first sensor 304 and the second port 307 is connected to the second sensor. The at least one sensor 303, 304 may be integrally formed within the adapter 300.

In using this adapter 300, a pressure such as a static pressure, or an air velocity or another quantity defining the airflow in the flow path can be obtained before and after the choke part of the adapter. A control unit can then be arranged to control the flow generating unit based on a quantity differential. In detail, the quantity differential and the size of the first and second cross section areas, respectively, can be used for controlling the flow generating unit to obtain a desired airflow in the flow path.

As the first and second ports 306, 307 are arranged in the same part of the flow path, i.e., the distance between the first port 306 and the second port 307 is small, the value of the difference static pressure is characteristically reliable. Factors affecting the airflow in the flow path at the first port are characteristically affecting also the airflow at the second port.

The area change between the first and second area is characteristically smaller than 50% preferably smaller than 40% and in an example smaller than 30%. Thus, the second area has characteristically less than twice the size than the first cross section area or the second area has characteristically more than half the size of the first cross section area.

Characteristically, the distance in the flow direction between the ports is small. The distance is characteristically less than three times the largest diameter of the flow path in the measurement part, when the flow path has s circular cross section. If the flow path is not circular, the distance is characteristically less than three times the largest distance between the inner walls of the flow path in the measurement part in a direction perpendicular to the flow direction.

In an example, the distance is characteristically less than one time or less then half the largest diameter of the flow path in the measurement part, when the flow path has s circular cross section. In analogy therewith, if the flow path is not circular, the distance is less than one time or less than half the largest distance between the inner walls of the flow path in the measurement part in a direction perpendicular to the flow direction.

In an example, the at least one sensor is arranged directly in the flow path without being in communication with the flow path via a connection to ports 306, 307 in the flow path.

The adapter 300 may be arranged upstream a metering device of a feed system for an agricultural product. This may even further decrease influence from uncertainty factors from the measurements, as measurements are not disturbed by material and dirt entering the flow path via the metering device.

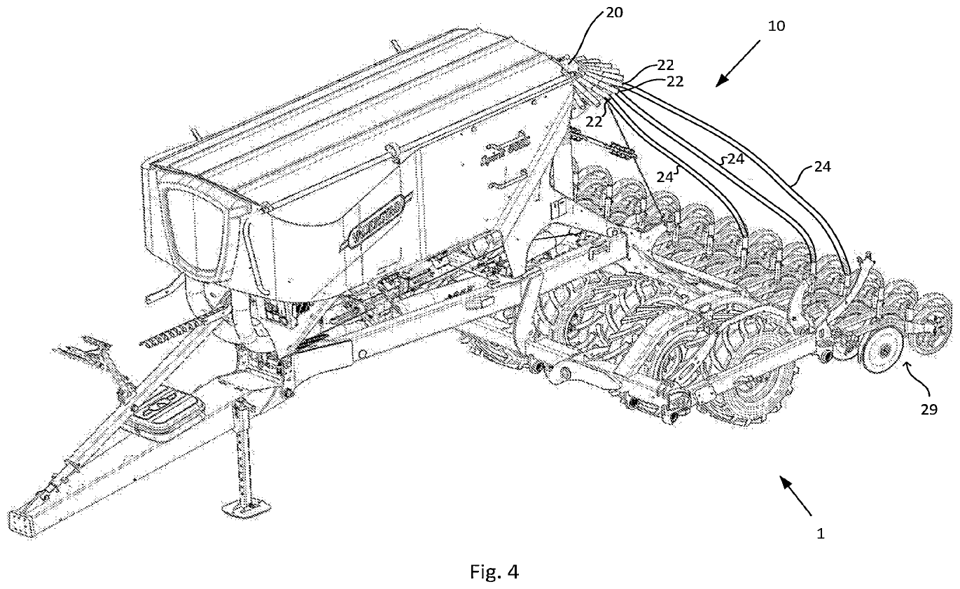

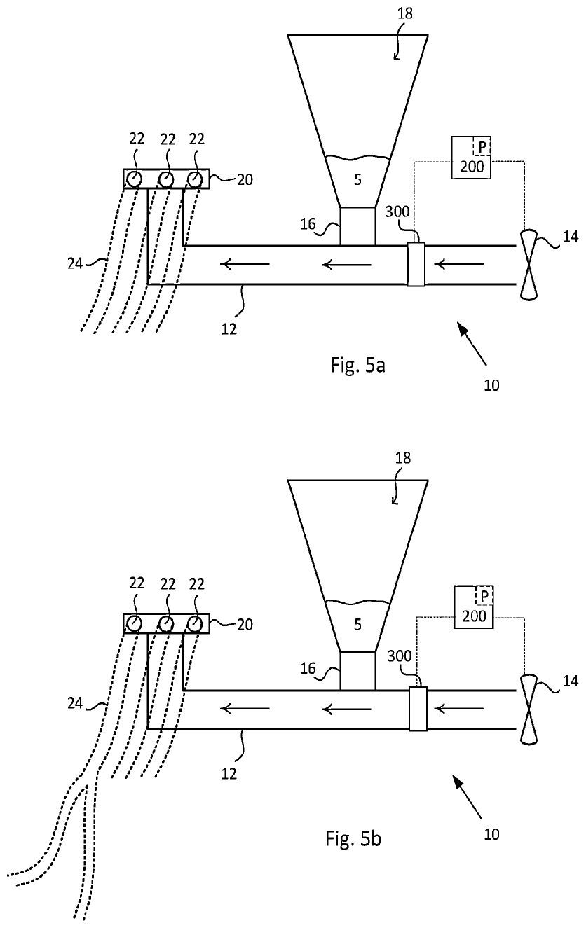

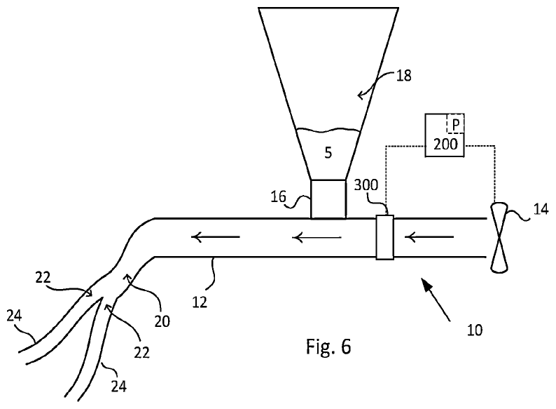

FIG. 4 schematically illustrates a perspective view of an agricultural implement 1 according to an example of the present disclosure. The agricultural implement 1 comprises a feed system 10 for distributing at least one agricultural product. The feed system 10 will be further described in relation to FIGS. 5a-5b and FIG. 6, which schematically illustrates different configurations of the feed system 10 according to examples of the present disclosure.

The agricultural implement 1 as shown in FIG. 4 is illustrated as a seed drill. However, the agricultural implement may comprise a planter, a fertilizing applicator, a pesticide applicator and/or any other similar devices. The at least one agricultural product to be distributed by means of the agricultural implement 1 may comprise seeds, fertilizer, pesticides and/or other similar products. In FIG. 1, the distribution unit 20 is schematically illustrated as a distribution head distributing the agricultural product via numerous outlets 22. Each outlet 22 of the distribution unit 20 may be connected to a first end of a separate duct 24 leading the agricultural product to coulters 29 and/or the ground. In FIG. 4, only three ducts 24 are schematically illustrated. However, a separate duct 24 may be arranged at each outlet 22 from the distribution unit 20. The second end of each duct 24 may be arranged in association with a coulter 29 and/or some sort of outlet nozzle and is thus arranged close to the soil in order to discharge the agricultural product.

FIG. 5a schematically illustrates a side view of a feed system 10 of an agricultural implement 4 according to an example of the present disclosure. The agricultural implement 1 may be configured as disclosed in FIG. 4. The feed system 10 comprises: a flow path 12; an airflow generating unit 14 arranged in fluid communication with the flow path 12; a metering device 16 arranged to provide an agricultural product 5 to the airflow in the flow path 12; and at least one distribution unit 20 connected to the flow path 12 downstream of the metering device 16. The at least one distribution unit 20 comprises at least one outlet 22, wherein each may be connected to a separate duct 24 for conveying the agricultural product 5 to the ground. The feed system 10 further comprises a control unit 200. The control unit 200 is arranged to control the airflow generating unit to obtain a desired airflow in the flow path. The control unit 200 may be configured to perform control as disclosed in relation to FIG. 1.

As illustrated in FIG. 5a, the metering device 16 may be arranged downstream of the airflow generating unit 14 and upstream of the distribution unit 20. The metering device 16 may be configured to discharge the agricultural product 5 into the airflow generated by the airflow generating unit 14. The metering device 16 may be controlled to regulate the amount of agricultural product 5 supplied into the airflow in the flow path 12. The metering device 16 may be arranged to feed agricultural product 5 from a product chamber 18 into the flow path 12 for feeding the agricultural product 5 to the ducts 24. The product chamber 18 may be a seed hopper or a fertilizer hopper. The product chamber 18 may be a combined seed and fertilizer hopper, accommodating a chamber for seeds and a chamber for fertilizer. The metering device 16 may comprise a rotating dosing element, such as rotating a cell wheel or a feed screw.

Downstream of the metering device 16, the feed system 10 may comprise one or more distribution units 20 with a plurality of outlets 22.

In FIG. 5a, the distribution unit is schematically illustrated as a distribution head, receiving the agricultural product 5 from below and distributing the agricultural product 5 radially/laterally via numerous outlets 22. Each outlet 22 of the distribution unit 20 may be connected to a first end of a separate duct 24 leading the agricultural product 5 to coulters and/or the ground. The second end of each duct 24 may be arranged in association with a coulter and/or some sort of outlet nozzle and is thus arranged close to the soil in order to discharge the agricultural product 5.

According to another example, the feed system 10 may comprise multiple flow paths 12 (not shown). The multiple flow paths 12 may each have a separate airflow generating unit 14, or share the same airflow generating unit 14. The multiple flow paths 12 may each have a separate metering device 16, or share the same metering device 16.

FIG. 5b schematically illustrates a side view of a feed system 10 of an agricultural implement 1 according to an example of the present disclosure. The agricultural implement 1 may be configured as disclosed in FIG. 1 and the feed system 10 may be configured as disclosed in FIG. 2a with the difference that one or more of the at least one separate duct 24 may branch out and split into multiple sub-ducts.

FIG. 6 schematically illustrates a side view of a feed system 10 of an agricultural implement 1 according to an example of the present disclosure. The agricultural implement 1 may be configured as disclosed in FIG. 1. The feed system 10 comprises: a flow path 12; an airflow generating unit 14 arranged in fluid communication with the flow path 12; a metering device 16 arranged to provide the agricultural product 5 to the airflow in the flow path 12; and at least one distribution unit 20 connected to the flow path 12 downstream of the metering device 16. The at least one distribution unit 20 comprises at least one outlet 22, wherein each may be connected to a separate duct 24 for conveying the agricultural product 5 to the ground. The feed system 10 comprises further a control unit 200.

According to the examples illustrated in FIGS. 5a-5b and FIG. 6, the control unit 200 is arranged to control the airflow generating unit to obtain a desired airflow in the flow path for example as exemplified in relation to FIG. 1.

It is to be understood that the control unit 200 may be implemented as a separate entity or distributed in two or more physical entities. The control unit 200 may comprise one or more control units and/or computers. The control unit 200 may comprise a processor and a memory, the memory comprising instructions, which when executed by the processor causes the control unit 200 to perform the herein disclosed method steps.

According to an example, a computer program P comprising instructions which, when the program is executed by a computer, causes the computer to perform the method as disclosed herein is provided. The computer program P is schematically illustrated in FIGS. 5a-5b and 6. According to an example, a computer-readable medium comprising instructions, which when executed by a computer, causes the computer to carry out the method as disclosed herein is provided.

The foregoing description of the preferred examples of the present disclosure is provided for illustrative and descriptive purposes. It is not intended to be exhaustive or to restrict the invention to the variants described. Many modifications and variations will obviously be apparent to one skilled in the art. The examples of the present disclosure have been chosen and described in order best to explain the principles of the invention and its practical applications and hence make it possible for specialists to understand the invention for various embodiments and with the various modifications appropriate to the intended use.

1. An agricultural implement (1) comprising a feed system (10) for at least one agricultural product (5), the feed system (10) comprising:
a flow path (12);
an airflow generating unit (14) arranged in fluid communication with the flow path (12);
at least one metering device (16) arranged to provide the at least one agricultural product (5) to the airflow in the flow path (12);
at least one distribution unit (20) connected to the flow path (12) downstream of the at least one metering device (16), wherein the at least one distribution unit (20) comprises at least one outlet (22),
at least one sensor (303, 304) arranged to measure a quantity relating to the airflow in the flow path (12), and
a control unit (200) arranged to control the airflow generating unit (14) to obtain a desired airflow in the flow path based on measurements by the at least one sensor,
wherein:
the flow path comprises a measurement part comprising a first part (301) having a first cross section area and a second part (302) having a second cross section area, wherein the size of the first cross section area is different from the size of the second cross section area,
the at least one sensor is arranged to measure the quantity relating to the airflow in the flow path at the first part and at the second part, and
the control unit (200) is arranged to control the airflow generating unit (14) to obtain the desired airflow in the flow path based on the measured quantity relating to the airflow in the flow path at the first part and at the second part and based on a relation between the size of the first cross section area and the second cross section area.

2. The agricultural implement (1) according to claim 1, wherein the measurement part is formed in an adapter (300) positioned in the flow path.

3. The agricultural implement according to claim 1, wherein the control unit (200) is arranged to control the airflow generating unit (14) based on a differential pressure between a pressure in the first part and a pressure in the second part, wherein the differential pressure may be a differential static pressure, said differential pressure being obtained from the measured quantity relating to the airflow in the flow path at the first part and at the second part.

4. The agricultural implement according to claim 1, wherein the at least one sensor comprises at least one pressure sensor, such as a static pressure sensor.

5. The agricultural implement according to claim 1, wherein the at least one sensor comprises a first sensor (303) arranged to measure the quantity at the first part and a second sensor (304) arranged to measure the quantity at the second part and wherein the control unit is arranged to determine a relation between the measurement at the first and second parts.

6. The agricultural implement according to claim 5, wherein the at least one sensor comprises at least one airflow sensor such as a vane sensor and/or a hot wire sensor.

7. The agricultural implement according to claim 1, wherein the first part comprises a first port and wherein the second part comprises a second port and wherein the first and second ports are connected to the sensor measuring a difference between the quantity relating to the flow path at the first part and at the second part.

8. The agricultural implement according to claim 1, wherein the at least one sensor is integrally formed with the adapter.

9. The agricultural implement according to claim 1, wherein the adapter is arranged upstream the at least one metering device.

10. The agricultural implement according to claim 1, wherein the control unit is arranged to provide a signal for control of the airflow generating unit also to a Load Sensing, LS, system/valve, to thereby request a desired hydraulic pressure to the implement based on the control signal.

11. The agricultural implement according to claim 1, wherein the at least one distribution unit (20) comprises at least two outlets (22).

12. A method for controlling an airflow in a feed system (10) for at least one agricultural product (5) of an agricultural implement (1), the feed system (10) comprising: a flow path (12); an airflow generating unit (14) arranged in fluid communication with the flow path (12); at least one metering device (16) arranged to provide the at least one agricultural product (5) to the airflow in the flow path (12); at least one distribution unit (20) connected to the flow path (12) downstream of the at least one metering device (16), wherein the at least one distribution unit (20) comprises at least one outlet (22) for conveying the agricultural product (5) to the ground; at least one sensor arranged to measure a quantity relating to the flow path; and a control unit arranged to control the airflow generating unit to obtain a desired airflow in the flow path based on measurements by the at least one sensor, the method comprising:
measuring at a measurement part of the flow path, using said at least one sensor, the quantity related to a current airflow at a first part having of the measurement part, said first part having a first cross section area and at a second part having a second cross section area, wherein the size of the first cross section area is different from the size of the second cross section area, and
controlling the airflow generating unit to obtain a desired airflow in the flow path based on the measurements of the quantity related to the airflow at the first part and at the second parts and based on a relation between the size of the first cross section area and the size of the second cross section area.

13. A computer program (P) comprising instructions which, when the program is executed by a computer, cause the computer to carry out the method according to claim 12.

14. A computer-readable media comprising instructions which, when executed by a computer, cause the computer to carry out the method according to claim 12.
